(19) United States
(12) Patent Application Publication
(10) Pub. No.: US 2014/0300686 A1
(43) Pub. Date: Oct. 9, 2014

(54) SYSTEMS AND METHODS FOR TRACKING CAMERA ORIENTATION AND MAPPING FRAMES ONTO A PANORAMIC CANVAS

(71) Applicant: TourWrist, Inc., San Francisco, CA (US)

(72) Inventors: Eric C. Campbell, San Francisco, CA (US); Balazs Vagvolgyi, San Francisco, CA (US); Alexander I. Gorstan, Owings Mills, MD (US); Kathryn Ann Rohacz, San Francisco, CA (US); Ram Nirinjan Singh Khalsa, Baltimore, MD (US); Charles Robert Armstrong, San Francisco, CA (US)

(21) Appl. No.: 13/843,387

(22) Filed: Mar. 15, 2013

(51) Int. Cl. H04N 5/232

(52) U.S. Cl. CPC H04N 5/23238
USPC 348/36

(57) ABSTRACT

A visual tracking and mapping system builds panoramic images in a handheld device equipped with optical sensor, orientation sensors, and visual display. The system includes an image acquirer for obtaining image data from the optical sensor of the device, an orientation detector for interpreting the data captured by the orientation sensors of the device, an orientation tracker for tracking the orientation of the device, and a display arranged to display image data generated by said tracker to a user.

### BACKGROUND

The present invention relates to systems and methods for tracking camera orientation of mobile devices and mapping frames onto a panoramic canvas.

Many mobile devices now incorporate cameras and motion sensors as a standard feature. The ability to capture composite panoramic images is now an expected feature for many of these devices. However, for many reasons the quality of the composite images and the experience of recording the numerous frames is undesirable.

It is therefore apparent that an urgent need exists for a system that utilizes advanced methods and orientation sensor capabilities to improve the quality and experience of recording composite panoramic images. These improved systems and methods enable mobile devices with and without motion sensors to automatically compile panoramic images, even with very poor optical data for the purposes of recording images that the limited field of view lens could not otherwise achieve.

### SUMMARY

To achieve the foregoing and in accordance with the present invention, systems and methods for tracking camera orientation of mobile devices and mapping frames onto a panoramic canvas is provided.

In one embodiment, a visual tracking and mapping system is configured to build panoramic images in a handheld device equipped with optical sensor, orientation sensors, and visual display. The system includes an image acquirer configured to obtain image data from the optical sensor of the device, an orientation detector that interprets the data captured by the orientation sensors of the device, an orientation tracker designed to track the orientation of the device using the data obtained by said image acquirer and said orientation detector, a data storage in communication with said image acquirer and said tracker, and a display arranged to display image data generated by said tracker to a user.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an exemplary flow diagram, in accordance with some embodiment that describes at a high level the process by which realtime mapping and tracking is achieved;

FIG. 2 is an exemplary flow diagram, in accordance with some embodiment that describes the process by which the initial orientation of the device is detected and applied during step 110 of FIG. 1;

FIG. 3A is an exemplary flow diagram expanding on step 120 in FIG. 1, in accordance with some embodiment that describes the process by which the orientation of each frame is determined and tracked and the image data is progressively mapped onto the canvas based on spherically warped image data;

FIG. 3B is an illustration related to the exemplary flow diagram in FIG. 3A depicting how the orientation of each frame is derived from key points and how the subsequent progressive image mapping may appear.

FIG. 4A is an exemplary flow diagram of an alternative approach expanding on step 120 in FIG. 1, in accordance with some embodiment that describes the process by which the orientation of each frame is determined and tracked and the image data is progressively mapped onto the canvas based on spherically warped image data;

FIG. 4B is an illustration related to the exemplary flow diagram in FIG. 4A depicting how the panorama canvas is split up into grid of cells using a dimensional spatial partitioning algorithm and how subsequent frames are loaded and keypoints are detected within the canvas grid cells that are covered by the current frame;

FIG. 5A is an exemplary flow diagram describing an alternative method of tracking (gradient descent tracking) which does not use image features, but instead uses part of the camera frame and normalized cross-correlation (“NCC”) template matching. This can be paired with any mapping solution;

FIG. 6 is an exemplary flow diagram, in accordance with some embodiment, that describes the process by which the ends of the panoramic canvas are matched, adjusted and connected (“loop closure”) to achieve a seamless view;

FIG. 6B is an illustration depicting a panoramic image and, in particular, the overlapping areas which will be used during loop closure; and

FIGS. 7A-7E are exemplary flow diagrams and screenshots, in accordance with some embodiments, that describes the processes by which the images are further aligned and adjusted to provide the best possible desired quality.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. Alternative features serving the same or similar purpose may replace all features disclosed in this description, unless expressly stated otherwise. Therefore, numerous other embodiments of the modifications thereof are contemplated as falling within the scope of the present invention as defined herein and equivalents thereto. Hence, use of absolute terms, such as, for example, “will,” “will not,” “shall,” “shall not,” “must,” and “must not,” are not meant to limit the scope of the present invention as the embodiments disclosed herein are merely exemplary.

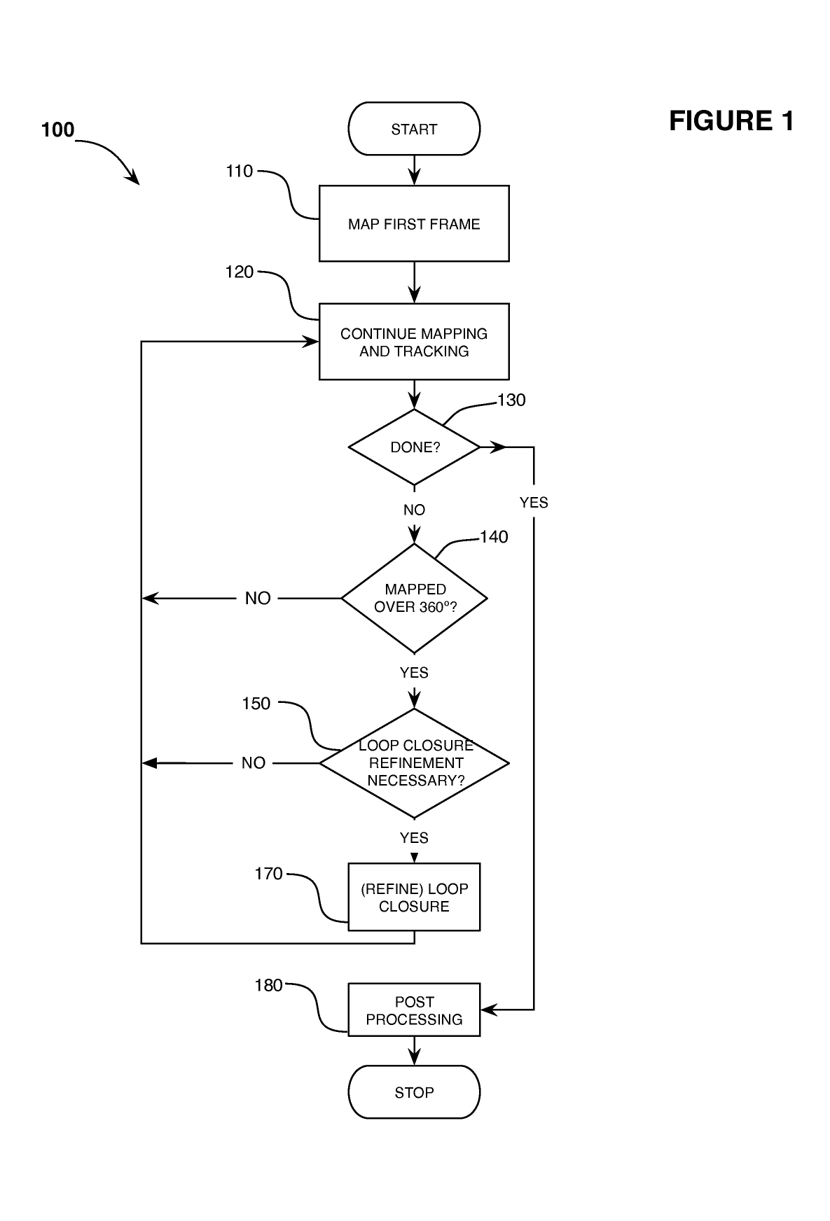

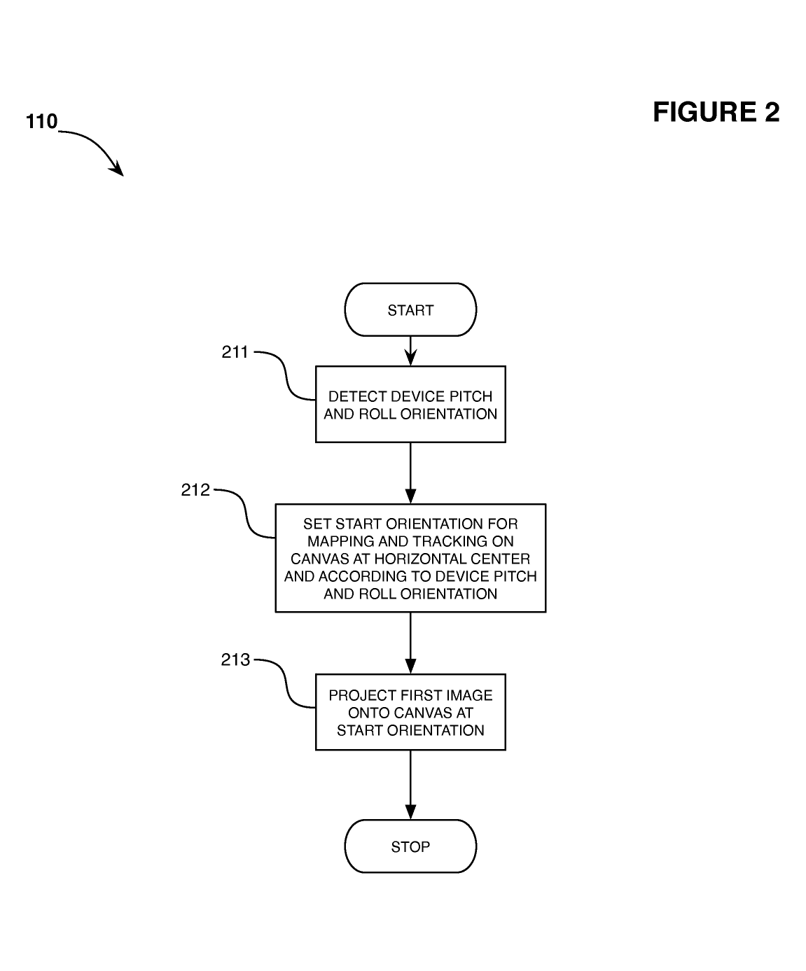

The present invention relates to the systems and methods for recording panoramic image data wherein a series of frames taken in rapid succession (similar to a video) is processed in real-time by an optical tracking algorithm. To facilitate discussion, FIGS. 1 is a high level flow diagram illustrating the process by which realtime tracking of camera orientation of a mobile device and mapping of frames onto a panoramic canvas is achieved. Note that mobile devices can be any one of, for example, portable computers, tablets, smart phones, video game systems, their peripherals, and video monitors.

Optical tracking and sensor data may both be used to estimate each frame's orientation. Once orientation is determined, frames are mapped onto a panorama canvas. Error accumulates throughout the mapping and tracking process. Frame locations are adjusted according to bundle adjustment techniques that are used to minimize reprojection error. After frames have been adjusted, post-processing techniques are used to disguise any remaining errant visual data.

The process begins by appropriately projecting the first frame received from the camera 110. The pitch and roll orientation are detected from the device sensors 211. The start orientation is set at the desired location along the horizontal axis and determined location and rotation along the vertical and z-axis (the axis extending through device perpendicular to the screen) 212. The first frame is projected onto the canvas according to the start orientation 213.

Each subsequent frame from the camera is processed by an optical tracking algorithm, which determines the relative change of orientation the camera has made from one frame to the next. Once the orientation has been determined, the camera frame is mapped onto the panorama map 120.

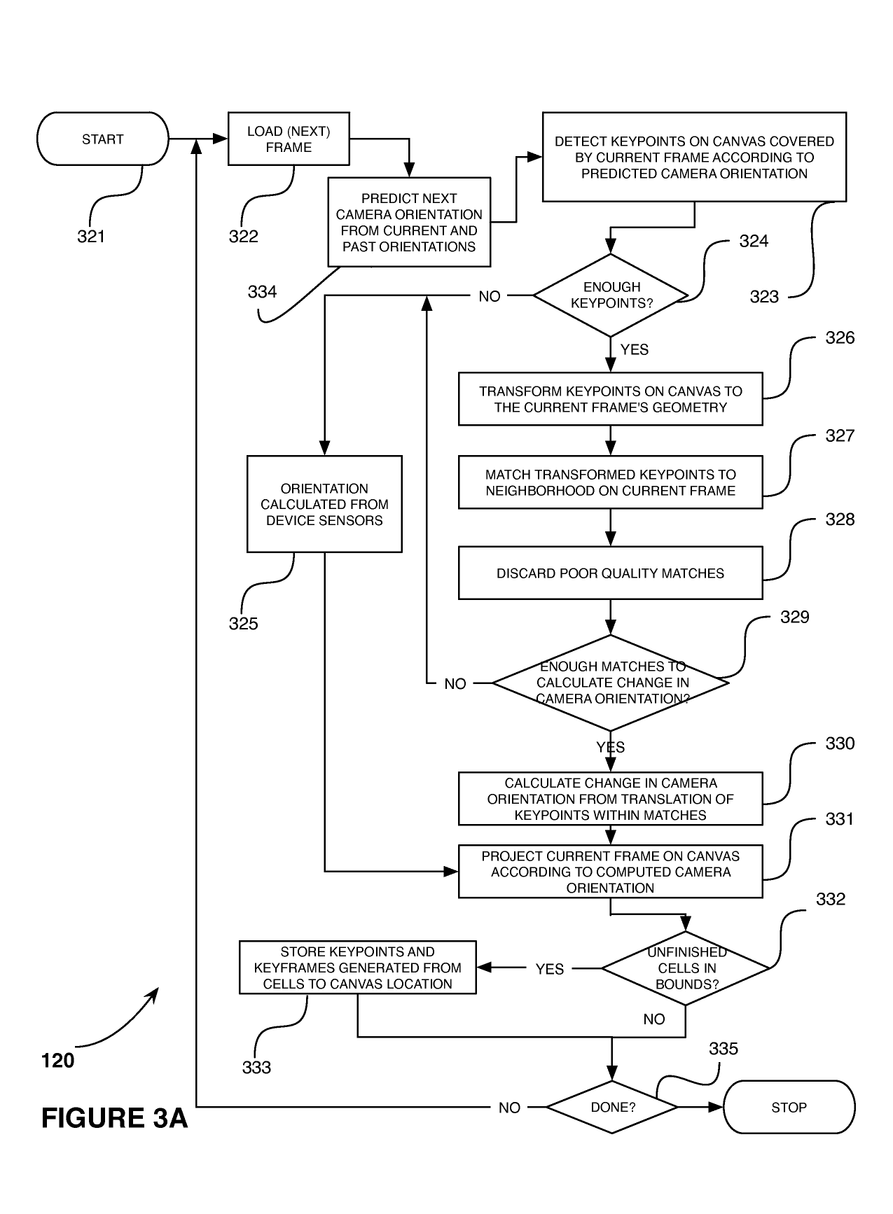

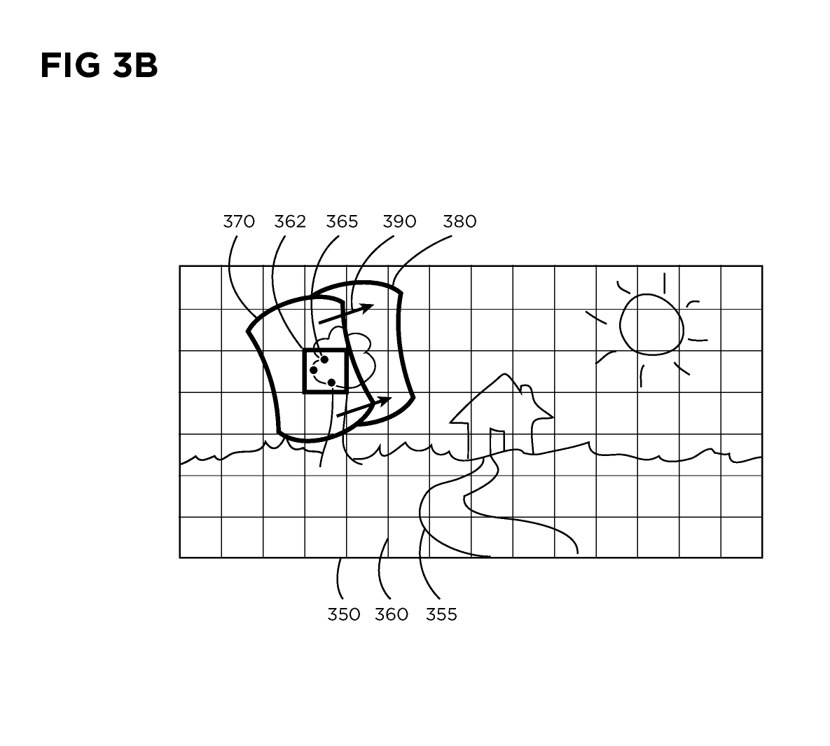

The next subsequent frame is loaded 322. Before each frame is processed by the optical tracker, the relative change of orientation is estimated by using a constant motion model, where the velocity is the difference in orientation between the previous two frames. When sensors are available, the sensors are integrated into the orientation estimation by using the integrated sensor rotation since the last processed frame as the orientation estimation 334. In this model of mapping and tracking (as represented by FIGS. 3A and 3B), the panorama canvas 350 is split up into grid cells 360. When a camera frame 370 is projected onto the canvas and a cell becomes completely filled with pixel data 362, keypoints 365 are detected for that cell 362 on the canvas 323, 350 and used in subsequent frames 380 for tracking 390. Once there are enough keypoints 324, the tracking is based on the spherically warped pixel data 355 on the panorama canvas 326, 350. Transformed keypoints are then matched to keypoints in the same neighborhood on the current frame 327. Poor quality matches are discarded 328. If enough matches remain 329, for each subsequent frame 380, keypoints 365 on the canvas 350 within the current camera's orientation are backwards projected into image space and used to determine the relative orientation change 390 between the current 380 and previous 370 frame 330. This uses multiple resolutions to refine the orientation to sub pixel accuracy. The current frame is then projected onto the canvas based on the computed camera orientation 331. Keypoints and keyframes of any unfinished cells are stored 333.

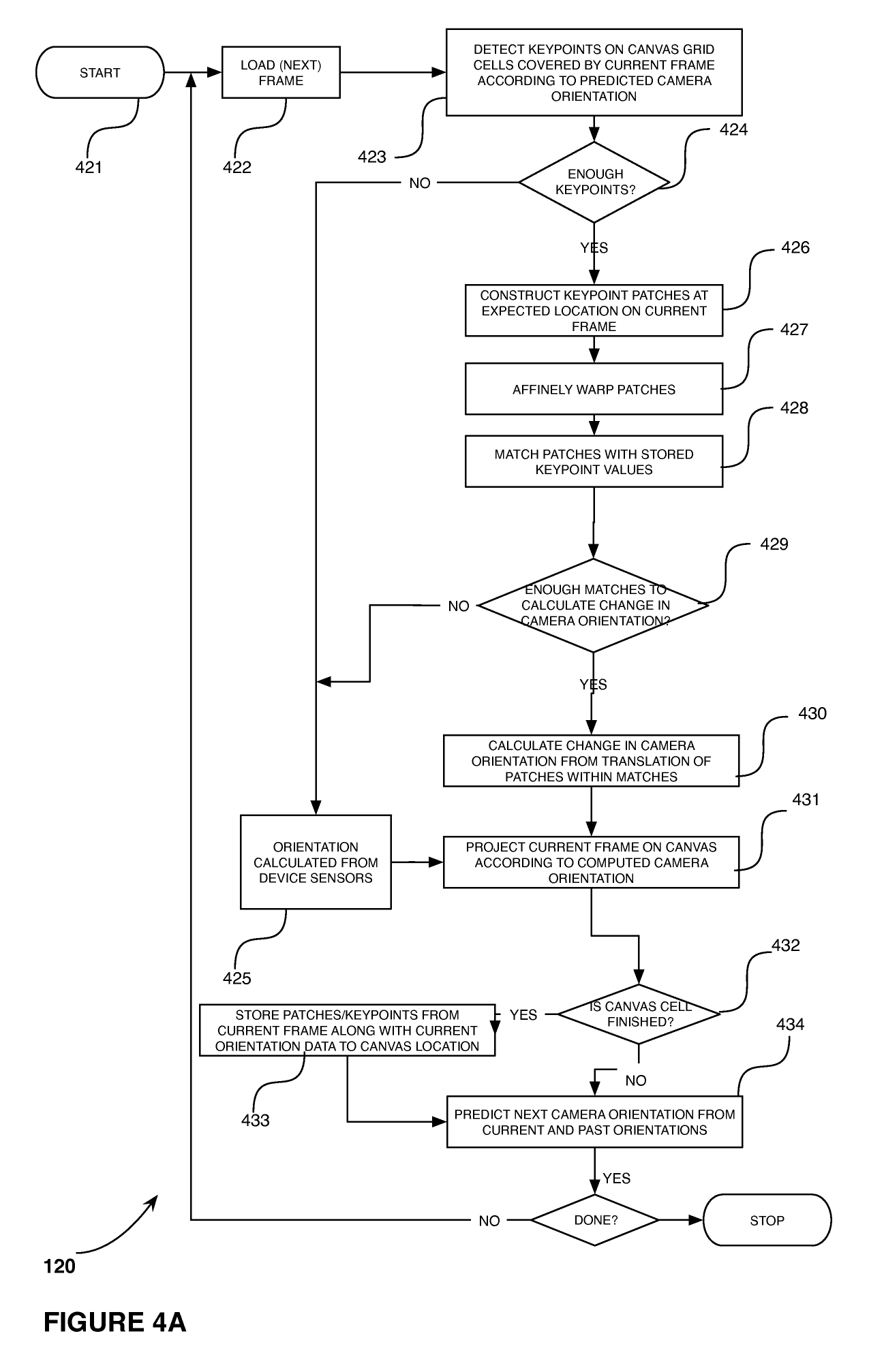

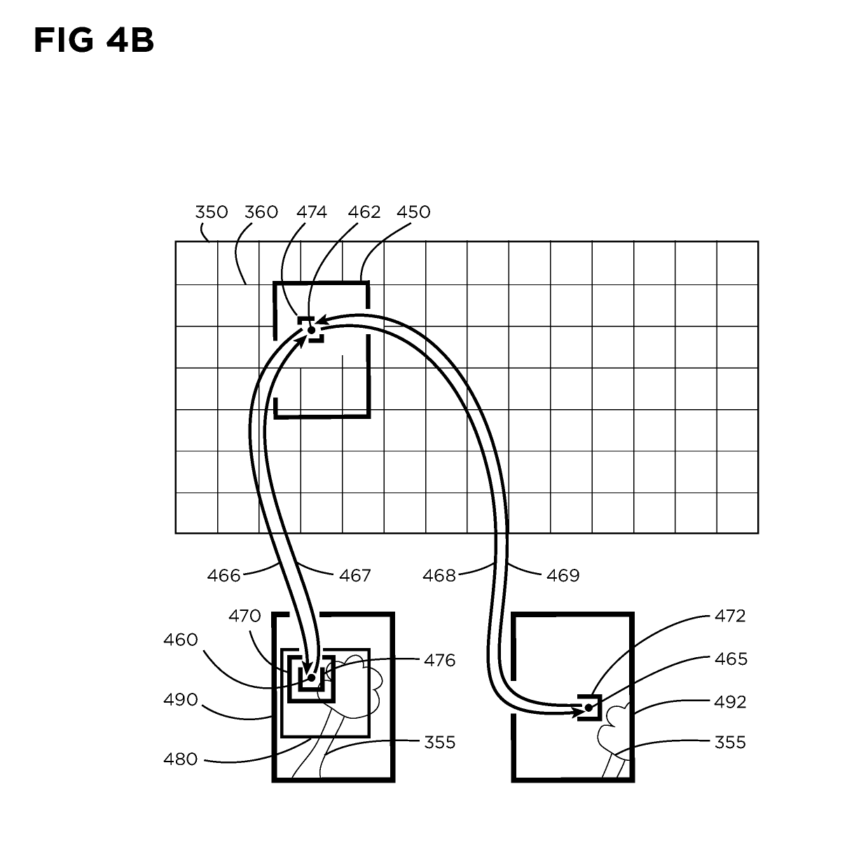

In an alternative model of mapping and tracking (represented by FIGS. 4A and 4B), the panorama canvas 350 is also split up into grid of cells 360 using a 2 dimensional spatial partitioning algorithm. Once a subsequent frame is loaded 422, keypoints are detected within the canvas grid cells that are covered by the current frame 423. If there are enough keypoints 424, keypoint patches are constructed at expected locations on the current frame 426. If there are not enough keypoints 424 or matches 429, the orientation is calculated from device sensors 425. Patches are then affinely warped 427 and patches are matched with stored keypoint values 428. If there are enough matches to calculate the change in camera orientation 429, then the change in camera orientation is calculated from the translation of matched patches 430. Once the camera orientation is calculated, whether with sensors 425 or matches 430, the current frame is then projected on the canvas according to that computed camera orientation 431. When a cell is completely within the projected bounds 450 of the current camera orientation, it is then considered filled 432, and image features are detected on the camera frame 433. The keypoint positions 460 are forward projected 467 onto the panorama canvas 350 and the current camera orientation, frame keypoint location 460, canvas keypoint location 462, and the image patch 470 are stored for each keypoint 460 in that cell 480, 433. The image feature patches 470 are based on the original camera frame 490 when completing a cell, with an n×n patch 470 around each keypoint 460 used for tracking subsequent frames. This uses multiple resolutions to refine the orientation to sub pixel accuracy.

In each subsequent frame, for each keypoint:

1. Backward project 468 the estimated keypoint location 462 onto the pano canvas 350, using the current camera orientation, onto current frame space 492.

2. Construct bounds of patch 472 around keypoint location 465 on current frame

3.Forward project 469 the 4 corners of the bounds of patch 472, using current camera

4.Backward project 466 the 4 corners of the bounds of patch 474 in pano canvas 350 space onto the cell frame 490, using the keypoint cell's camera

5. Make sure the bounds of patch 476 projected bounds are inside the stored patch's bounds 470

6.Affinely warp the pixel data inside patch 472 into a warped patch

7. Match the warped patch against the current frame template search area, using NCC

Outliers are then removed, and the correspondences are used in an iterative orientation refinement process until the reprojection error is under a threshold or the number of matches is less than a threshold. Using the current camera orientation and the past camera orientation, it's possible to predict the next camera orientation 434.

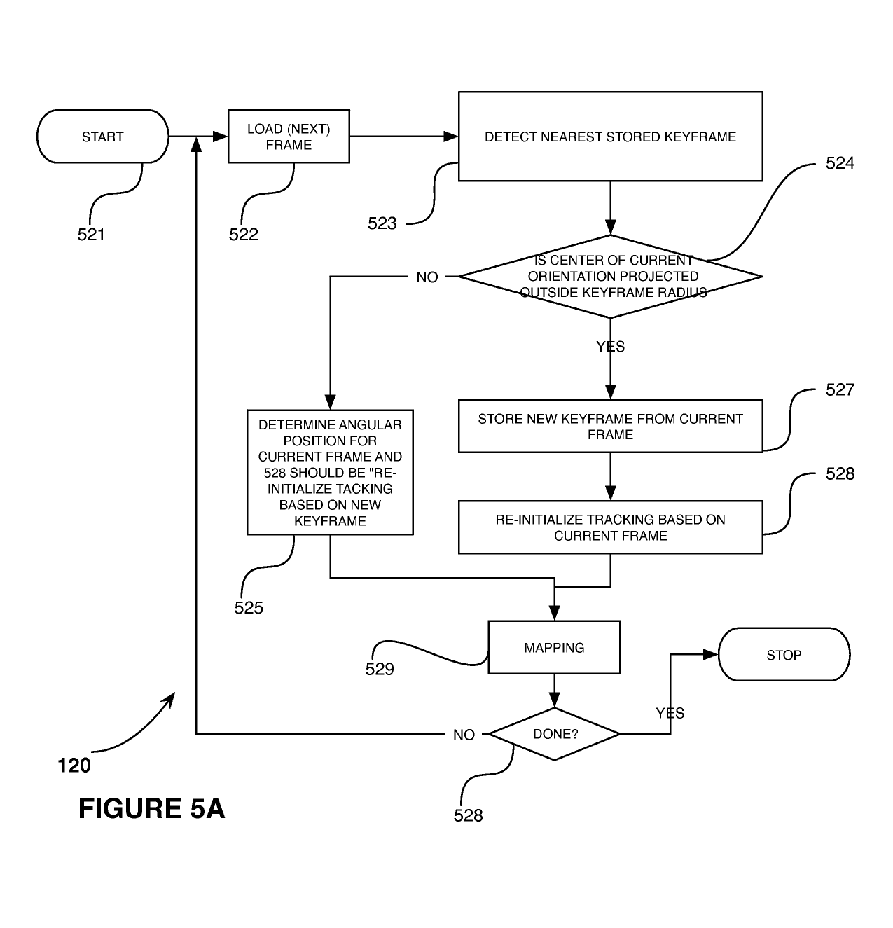

In another embodiment of mapping, as described in FIG. 5A certain video frames are selected from the video stream and get stored as keyframes. Frames are selected at regular angular distances in order to guarantee that the keyframes are distributed evenly on the panorama 524. The selection algorithm is as follows: As a video frame gets captured 522, the method determines which previously stored keyframe is the closest to it 523, then it calculates the angular distance 525 between said keyframe and the video frame. When, for any frame, said distance is larger than a preset threshold, the frame gets added as a new keyframe 527. The frame gets added as a new keyframe and tracking gets re-initialized 528. In order to determine the angular position of each video frame, this method calculates the camera orientation change using image tracking The tracking is formulated as an optimization problem where it is sought to find for every frame the camera parameters (yaw, pitch, roll) of the transformation function that maximize the Normalized Cross Correlation between the closest keyframe and current frame. For finding the camera parameters, Gradient Descent optimization is employed. There are various mapping methods 529, including the two below.

In CPU based canvas mapping, the bounds of each camera frame are forward projected onto the canvas after orientation refinement, creating a run length encoded mask of the current projection. Because you can have gaps and holes in your image when forward projecting with a spherical projection, the pixels are backwards projected within the mask in order to interpolate the missing pixels and fill the gaps. When doing continuous mapping, a run length encoded mask of the entire panorama is maintained, which is subtracted from the Run Length Encoding (“RLE”) mask of the current frame's projection, resulting in an RLE mask containing only the new pixels. When a key frame is stored, the entire current frame on the pano map can be overwritten.

In OpenGL based canvas mapping, the same mapping process is done as in the CPU based canvas mapping, except it's done on the GPU using OpenGL. A rendertarget is created the same size as the panorama canvas. For each frame rendered, the axis aligned bounds of the current projection are found, and four vertices to render a quad with those bounds is constructed. The current camera image and refined orientation are uploaded to the GPU and the quad is rendered. The pixel shader backwards projects the fragment's coordinates into image space and then converts the pixel coordinates to OpenGL texture coordinates to get the actual pixel value. Pixels on the quad outside the spherical projection are discarded and not mapped into the rendertarget.

Steps 333, 433, and 527 reference keyframe storage, which can be achieved in various ways. In one method, the panorama canvas is split up into a grid, where each cell can store a keyframe. Image frames tracked optically always override sensor keyframes. Keyframes with a lower tracked velocity will override a keyframe within the same cell. Sensor keyframes never override optical keyframes.

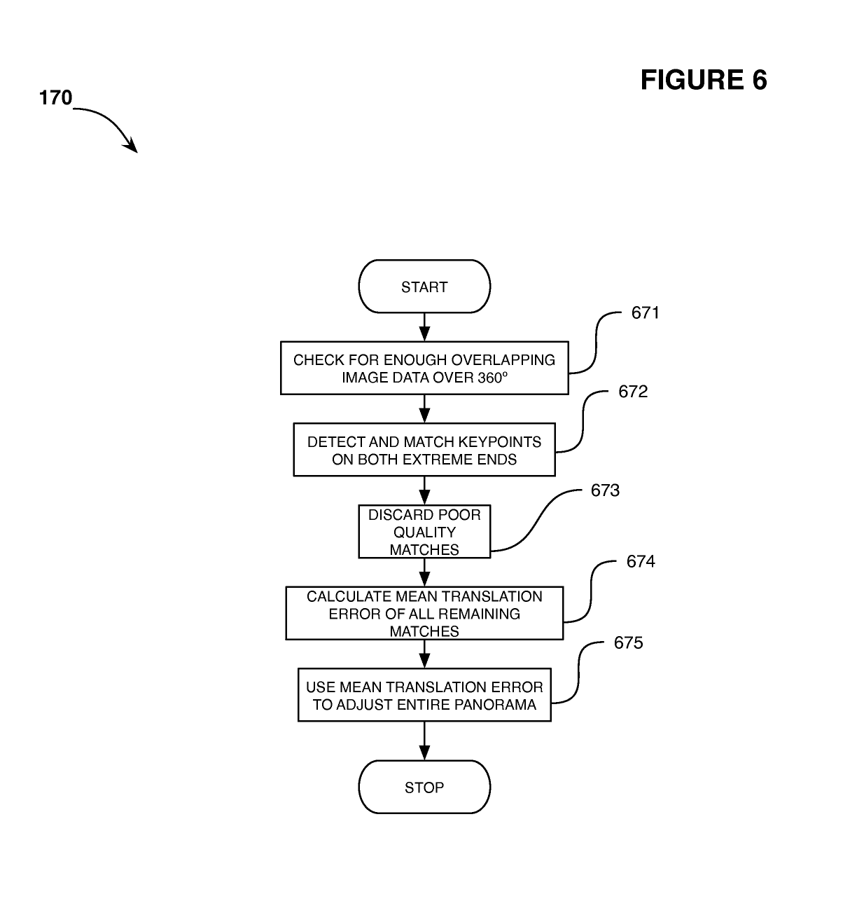

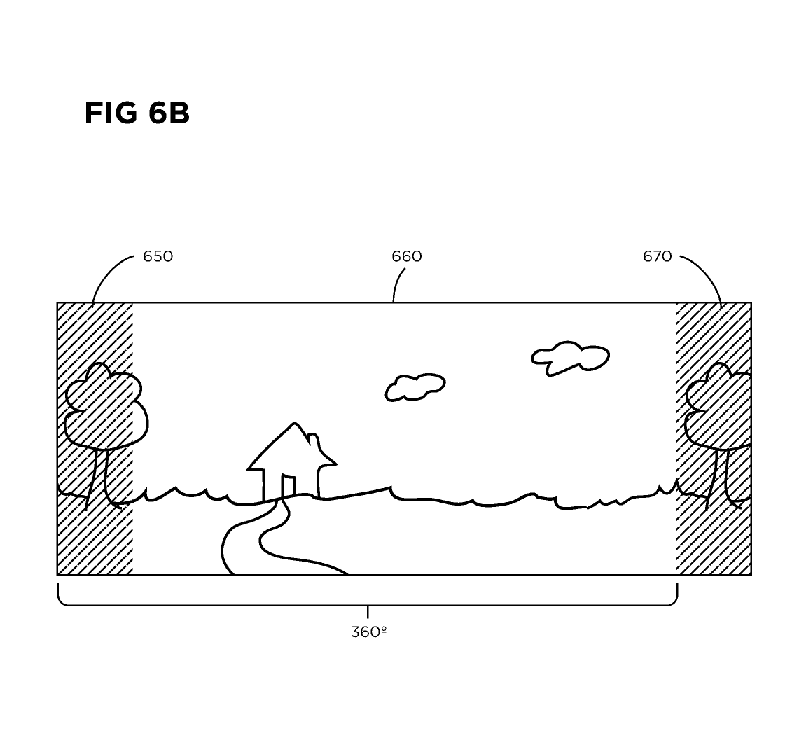

In FIG. 6, when the algorithm has detected that at least 360° has been captured on the canvas 660, plus a certain amount of overlap 671, it will then identify and compare features at the left end 650 and the other end of the overlapping image data 670. Matches on the extreme ends can then be filtered in order to reject incorrect matches 673. Ways to filter include setting a certain threshold for the distance between the two matching features as well as the mean translation error of all matches. Throughout the mapping and tracking process, error accumulates and can be accounted for at this point. Once the algorithm has determined the mean translation errors from end to end 674, it uses those values to adjust the entire panorama 675. This can be done in real-time, updating a live preview.

As a refinement step to the gradient-descent based tracker, when a new keyframe is selected, the camera parameters (yaw, pitch, roll) for each keyframe already stored are adjusted in a global gradient-descent based optimization step, where the parameters for all keyframes are adjusted.

In order to minimize processing time, each time a keyframe is added and bundle adjustment is done, one can select only the keyframes near the new keyframe's orientation. One can then run a full global optimization on all keyframes in post processing.

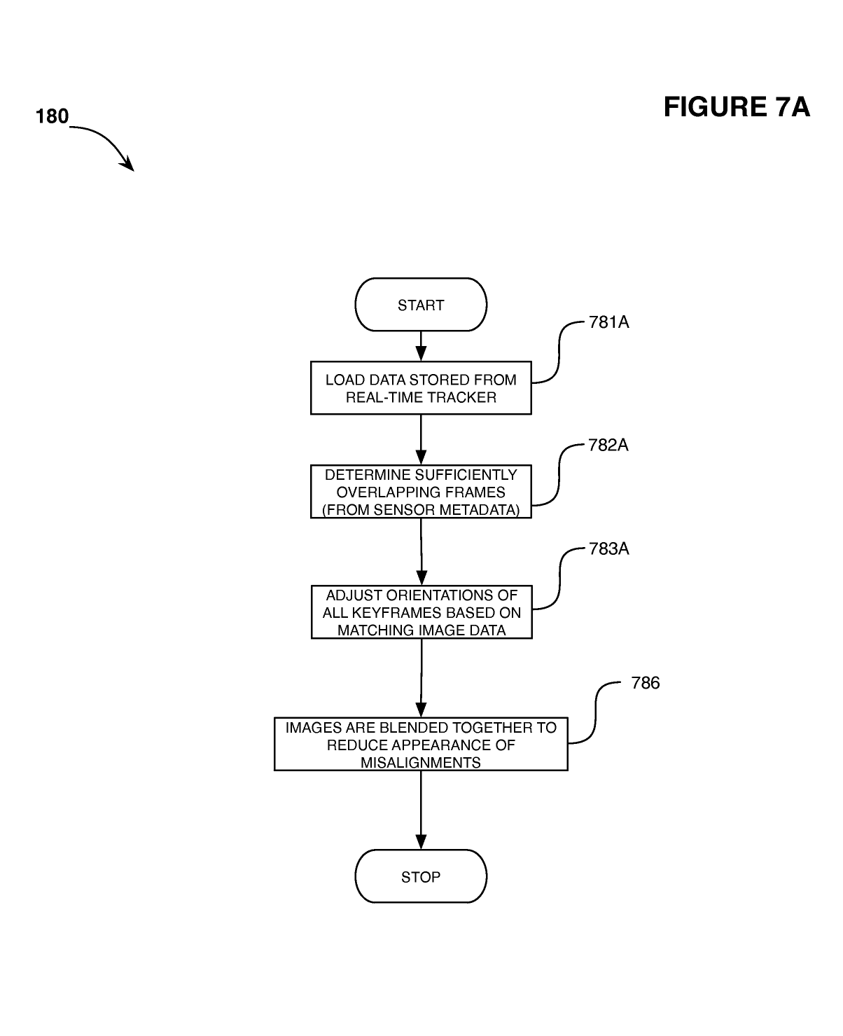

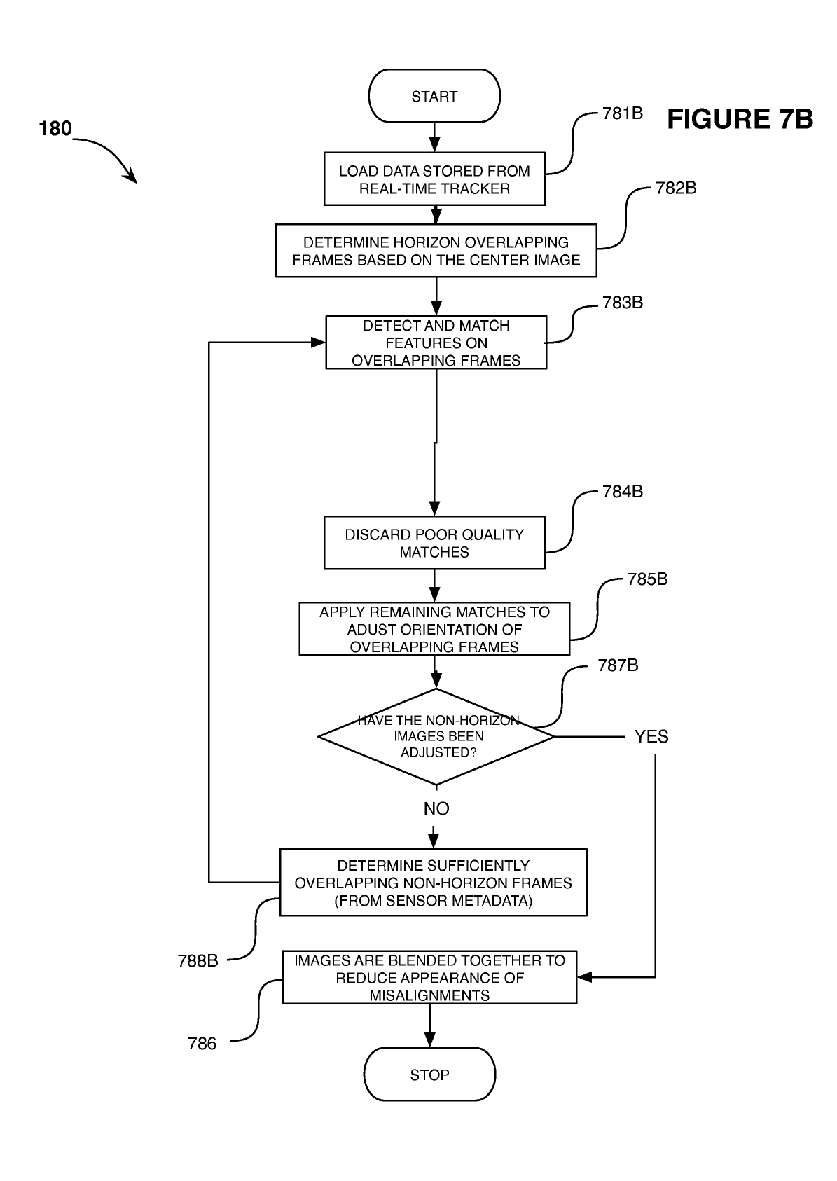

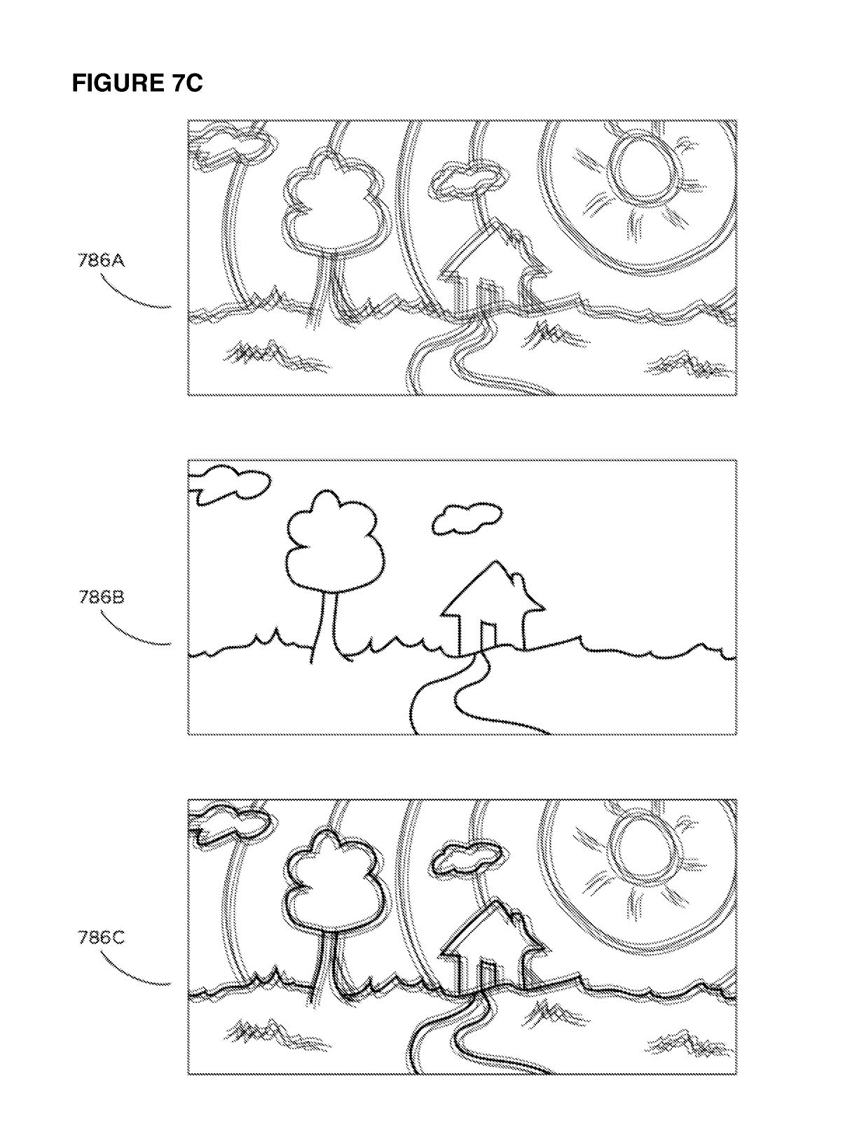

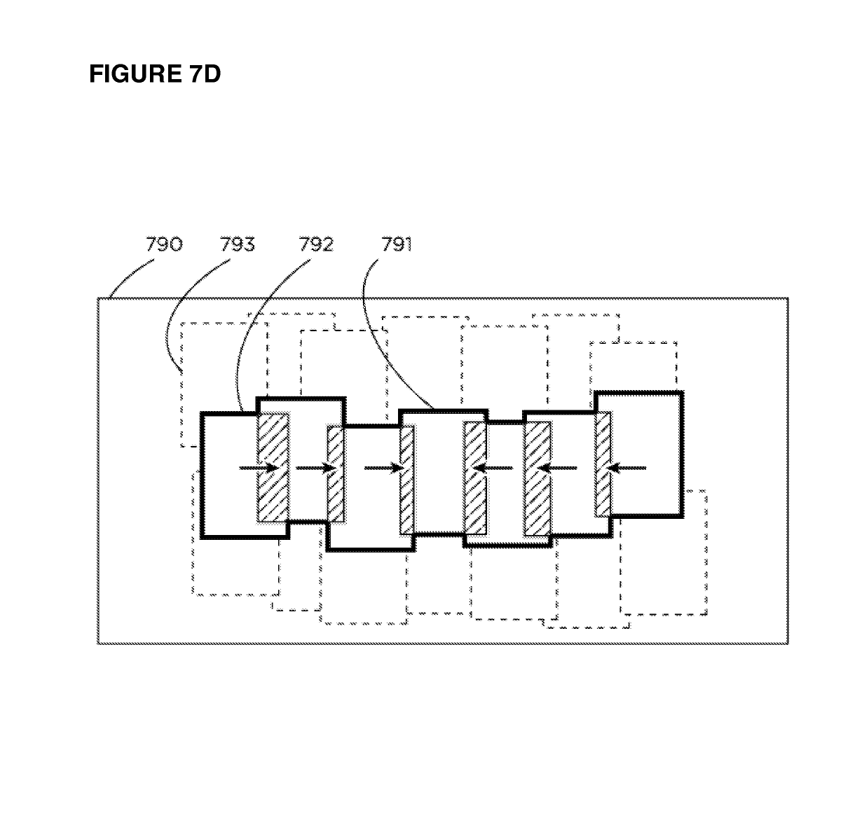

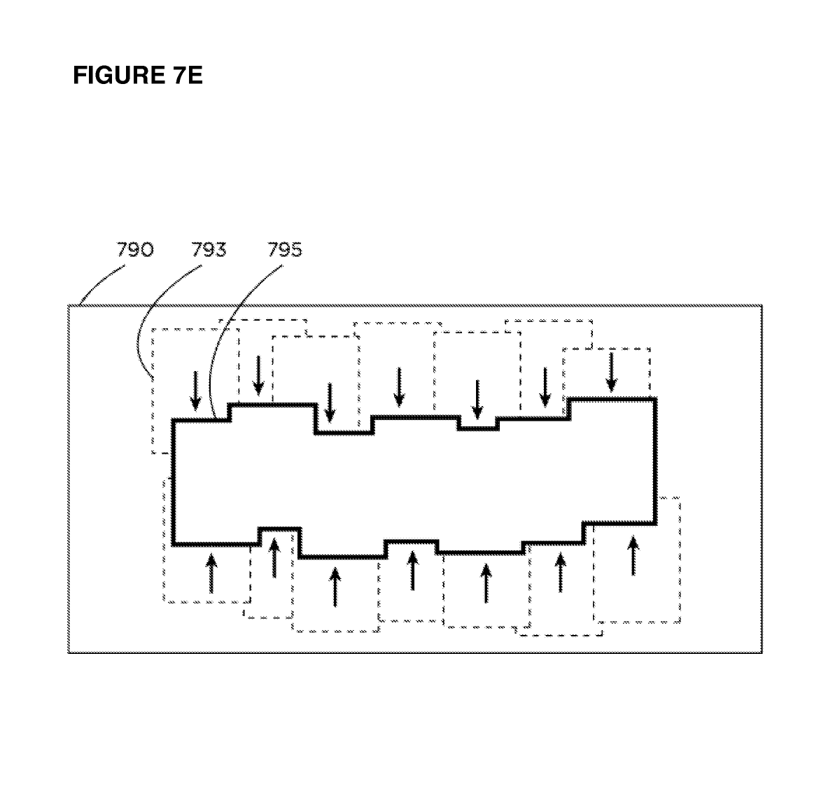

In FIG. 7A, an alternate method of post-processing employing global bundle adjustment begins by loading information stored from the real-time tracker 781A. Once this information has been loaded, frame matches, or frames that overlap, are determined based on the yaw, pitch, and roll readings 782A. Potential matches can then be filtered to ensure sufficient overlap. The algorithm then adjusts the orientations of all keyframes based on matching image data 783A. Images are then blended together to minimize any remaining visual data 786.

In FIGS. 7B, 7D and 7E, with horizon bundle adjustment, the center image 791 is left untouched, and every other image along the horizon 792 is adjusted according to its overlap with the center image 791. Once the data stored by the real-time tracker is loaded 781B, frames that overlap the horizon are determined based on the center image 782B. Features on overlapping frames are matched 783B, and poor quality matches are discarded 784B. Remaining matches are used to adjust the orientation of overlapping frames 785B. Once the horizon frames 795 have been adjusted, the positions are locked in place and sensor data is used to determine overlapping non-horizon frames 788B. Every image along the top 793 or bottom of the horizon 795 is adjusted towards the horizon by detecting features and matches along the horizon and using those correspondences to adjust the orientation. Once all frames have been adjusted, images are blended together during post-processing to minimize any remaining errant visual data 786.

In one method of blending, once image locations have been adjusted, images are blended together in an attempt to disguise any errant visual data caused by sources such as parallax. In order to reserve memory, the final panorama can be split up into segments where only one segment is filled at a time and stored to disk. When all segments are filled, they are combined into a final panorama. Within each segment, the algorithm separates sensor based frames from optically based frames.

In another method, the border regions of each keyframe are mapped onto the canvas, where the alpha value of the borders are feathered. When mapping additional keyframes, the pixels are blended with the existing map as long as the alpha value is below a certain threshold, then the alpha on the map is added by a factor of the alpha value of the new pixel being mapped in that location, until the alpha value reaches that threshold; then there is no more blending happening along that seam. This allows us to blend multiple keyframes along a single edge, providing a rough seam, and allowing us to preserve the high level of detail in the center of the images.

FIG. 7C describes another alternative method of blending. Two canvases are used in the blender. One canvas stores low detail pixel data 786A, and another canvas stores the detailed pixel data 786B. For each frame mapped, the original frame is mapped to the low detail map, and then the original frame is blurred and the pixel values are subtracted from the original frame, leaving a frame containing only the detailed areas. This image can contain negative pixel values, requiring an image containing short data, increasing the memory usage significantly. When mapping to the low detail and high detail maps, the frames are feather blended together with different feathering parameters, allowing us to blend the low detail and high detail areas separately. Once all frames have been mapped to the low and high detail maps, the maps are combined by adding the pixel values from each map 786C. This allows us to blend low detail parts of the canvas over a longer area, removing seams and exposure differences, and allows us to preserve the high detailed areas of the panorama on top of the significantly blended low detail areas.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A visual tracking and mapping system configured to build panoramic images using a mobile device equipped with optical sensor, orientation sensors, and visual display, the system comprising:
an image acquirer configured to obtain image data from the optical sensor of the device;
an orientation detector configured to interpret the data captured by the orientation sensors of the device;
an orientation tracker configured to track the orientation of the device using the data obtained by said image acquirer and said orientation detector;
a data storage coupled to and configured to be in communication with said image acquirer and said tracker; and
a display configured to display image data generated by said tracker to a user.

2. The visual tracking and mapping system for building panoramic images according to claim 1, wherein said tracker selects a subset of acquired images, also known as keyframes, that are used for generating the panoramic image and said data storage stores those keyframes.

3. The visual tracking and mapping system for building panoramic images according to claim 2, wherein said tracker is configured to employ keyframe selection method that stores keyframes at regular angular distances in order to guarantee that the keyframes are distributed evenly on the panorama, and wherein the system is further configured to:
determine which previously stored keyframe is the closest to the acquired image;
calculate the angular distance between said closest keyframe and said acquired image; and
select said acquired image as keyframe when said angular distance is larger than a preset threshold.

4. The visual tracking and mapping system for building panoramic images according to claim 2, wherein said tracker estimates device orientation from acquired images by comparing previously stored keyframes to images acquired afterwards.

5. The visual tracking and mapping system for building panoramic images according to claim 4, wherein said tracker estimates device orientation by extracting image features from keyframes and locating said features on the acquired images using feature matching or image template matching methods.

6. The visual tracking and mapping system for building panoramic images according to claim 4, wherein orientation tracker is further configured to formulate as an optimization problem that finds the camera parameters (yaw, pitch, roll) of the transformation function that maximize the Normalized Cross Correlation or minimize the Sum of Absolute Difference between the closest keyframe and the acquired images.

7. The visual tracking and mapping system for building panoramic images according to claim 6, wherein said tracker is further configured to use camera parameters are found using Gradient Descent optimization.

8. The visual tracking and mapping system for building panoramic images according to claim 4, wherein said tracker is further configured to project keyframes onto the panorama image according the orientation of the device at the time of the acquisition of said keyframes.

9. The visual tracking and mapping system for building panoramic images according to claim 8, wherein said tracker is further configured to split the panorama image into segments and projects keyframes on it at least one segment at a time in order to reduce memory requirements.

10. The visual tracking and mapping system for building panoramic images according to claim 8, wherein said tracker is further configured to determine the location of visual seams between overlapping keyframes on the panorama image and blends said keyframes along the seam in order to lessen the visual appearance of the seam.

11. The visual tracking and mapping system for building panoramic images according to claim 8, wherein said tracker is further configured to analyze the regions of the panorama where keyframe projections overlap and uses optimization methods to refine keyframe orientations.

12. The visual tracking and mapping system for building panoramic images according to claim 11, wherein said optimization is Gradient Descent optimization that finds for every keyframe the camera parameters (yaw, pitch, roll) of the transformation function that maximize the Normalized Cross Correlation between overlapping keyframes.

13. The visual tracking and mapping system for building panoramic images according to claim 11, wherein said optimization is a Levenberg-Marquardt solver that finds for every keyframe the camera parameters (yaw, pitch, roll) of the transformation function that minimize the distance of matching image features between every pair of overlapping keyframes.

14. In a visual tracking and mapping system for building panoramic images including a mobile device equipped with optical sensor, orientation sensors, and visual display, a method comprising:
acquiring image data from the optical sensor of a mobile device;
interpreting the data captured by the orientation sensors of the device;
tracking the orientation of the device using the data obtained by said image acquisition and said orientation tracking; and
displaying image data generated by said tracking to a user.

15. In a computerized mobile device having a camera, a method for tracking camera position and mapping frames onto a canvas, the method comprising:
predicting a current camera orientation of a mobile device from at least one previous camera orientation of the mobile device;
detecting at least one canvas keypoint based on the predicted current camera orientation;
transforming the at least one canvas keypoint to current frame geometry, and affinely warp patches of the at least one keypoint;
matching the transformed at least one canvas keypoint to neighborhood of current frame;
computing a current camera orientation using the matched transformed at least one canvas keypoint; and
projecting a current frame onto canvas according to the computed current camera orientation.
